(19) United States
(12) Patent Application Publication
(10) Pub. No.: US 2008/0156224 A1
(43) Pub. Date: Jul. 3, 2008

(54) Method of fabricating transparent hydrophobic self-cleaning coating material and coating material and transparent coating made therefrom

(75) Inventors: Yi-Che Su, Pingtung County (TW); Yuung-Ching Sheen, Hsinchu County (TW); Ya-Tin Yu, Taipei County (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/882,718

(22) Filed: Aug. 3, 2007

(30) Foreign Application Priority Data
Dec. 27, 2006 (TW) 95149200

(51) Int. Cl. B32B 5/16

(52) U.S. Cl. 106/13; 106/448; 106/450; 106/481; 106/499; 106/501.1; 106/505; 427/201; 427/421.1; 427/428.01; 427/429; 427/430.1

(57) ABSTRACT

A method for forming a transparent hydrophobic self-cleaning coating material, comprising: providing particle precursors to form first particles; and reacting first particles with a low-surface-energy compound to form second particles, wherein the first particles are chemically bonded to the low-surface-energy compound and diameters of the second particles are less than 400 nm.

### BACKGROUND OF THE INVENTION

1. Field of the Invention

The invention relates to a coating technology, and more particularly to a transparent hydrophobic self-cleaning coating.

2. Description of the Related Art

Glass becomes dirty after long-term use. Diluted HF solution is frequently used to clean glass. HF solution is, however, harmful to humans and the environment. Thus, transparent, easy-cleaning coating materials have been developed. The transparent easy-cleaning coating materials allow glasses easy cleaning of difficult stains, and particularly, can maintain a transparent appearance of the glass. U.S. Pat. No. 6,997,018 issued to Ferro Corporation in 2006, discloses at high temperature (700-1200° C.) sintering inorganic particles having of less than 400 nm on the glass surface, and subsequently treating the glass with an F-based reagent at a temperature between 200-300° C. on the surface. The hydrophobicity and easy-cleaning ability of the glass are increased and the transparent appearance of the glass is not adversely affected. However, as the process requires high temperature and inert gas ambient, the operational cost is high. U.S. Pat. No. 6,858,284 issued to E. Nun et al. in 2005, discloses a self-cleaning material composed of crosslinkable PU/PU, acrylates/SiO₂ and acrylates/unsaturated (meth)acrylates and the particle size of which is about 1-1000 nm. The coating, material has self cleaning ability but is not transparent.

### BRIEF SUMMARY OF THE INVENTION

In a first aspect, the invention provides a method for forming a transparent hydrophobic self-cleaning coating material, comprising: (a) providing particle precursors to form first particles; and (b) reacting first particles with a low-surface-energy compound to form second particles, wherein the first particles are chemically bonded to the low-surface-energy compound and diameters of the second particles are less than 400 nm.

In a second aspect, the invention provides a transparent hydrophobic self-cleaning coating material by the method according the first aspect of the invention.

In a third aspect, the invention provides a transparent hydrophobic self-cleaning coating made form the coating material in the second aspect.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1A and 1B show the transmittance of the glass substrate at a wavelength between 400-800 nm before and after application of the transparent hydrophobic self-cleaning coating material, respectively; and

FIG. 1C shows the transmittance of the transparent hydrophobic self-cleaning coating after deducting the glass substrate.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The method of forming a coating material will be described here in greater detail. A transparent hydrophobic self-cleaning coating material with improved physical properties as well as sufficient surface hydrophobicity is obtained by chemical modification of the particle surfaces using a low-surface-energy compound. Preferably, a high contact angle and high weatherability transparent coating material can be attained and can be manufactured at room temperature. Other objects and advantages of the invention will become apparent from the following description.

These first particles are preferably prepared from wet synthesis process. Any known wet synthesis processes such as sol gel, hydrothermal, or precipitation process may be used. For example, the stating material includes water, solvent, and particle precursor. Particle precursor comprises metal alkoxide. Examples of the metal alkoxide include tetramethoxysilane (TMOS), tetraethoxysilane (TEOS), titanium tetraisopropoxide, titanium tetramethoxide, titanium tetraethoxide, titanium, tetrabutoxide and zirconium n-butoxide. The solvent may comprise an alcohol such as methanol, ethanol, isopropanol, or butanol. Other solvents, however, such as hexane, toluene, ketone or diethyl ether may be used. The precursors mentioned above may be refluxed for an extended period, such as a period of more than 5 minutes, preferably, from 0.5 to 24 hours to yield the first particles. For example, silicate gels may be prepared by hydrolyzing an alkoxide dissolved in an alcohol with a mineral acid or base, or organic acid or base. In the invention, first particles having a diameter of about 400 nm, preferably about 100 nm, and more preferably about 20 nm may be used for the formation of the coating material.

In the coating material of the invention, the first particles are reacted with a low-surface-energy compound to enhance the chemical hydrophobicity and form second particles, wherein the first particles are chemically bonded to the low-surface-energy compound. The reaction of the first particles and low-surface-energy compound are carried out at a temperature between 0-100° C. for several minutes to hours, preferably about 1-48 hours. The pH value of the reaction is preferably controlled at about 1-8, more preferably about 2-7. A conventional low-surface-energy compound may be used for enhancing chemical hydrophobicity of the particle surface. The frequently used low-surface-energy include Si-based low-surface-energy, F-based low-surface-energy and carbohydrate or hydrocarbon low-surface-energy. Si-based low-surface-energy includes siloxane, silane, or silicone. F-based low-surface-energy includes fluorosilanes, fluoroalkyl silanes (FAS), polytetrafluoroethylene (PTFE), polytrifluoroethylene, polyvinylfluoride, or functional fluoroalkyl compounds. Carbohydrate or hydrocarbon low-surface-energy includes reactive wax, polyethylene, or polypropylene. The preferred low-surface-energy is siloxane or fluoroalkyl silanes (FAS). The low-surface-energy compound mentioned above comprises a first functional group capable of bonding with the first particles. The first functional group may comprise SiOR or SiOH, wherein R is CH₃, C₂H₅, C₃H₇ or C₄H₉. Alternatively, surfaces of the first particles may be modified to comprise a second functional group capable of bonding directly with the low-surface-energy compound. The second functional group may comprise amino, epoxy, carboxyl or hydroxyl.

The second particles may be chemically bonded to a substrate directly. Alternatively, after forming the second particles, an adhesion promoter or crosslinker may be added to attach to the second particles by forming chemical bonds with the low-surface-energy compound on the second particle or directly with the second particles. The adhesion promoter or crosslinker chemically bonded to the second particle may increase the mechanical properties of the coatings, including adhesion and mechanical strength, without deteriorating the hydrophobicity. When the adhesion promoter or crosslinker is provided, the low-surface-energy compound may have a third functional group capable of bonding with the adhesion promoter or crosslinker, wherein the third functional group comprises vinyl, amino, epoxy, carboxyl, hydroxyl, or isocyanate. Suitable conventional adhesion promoters or crosslinkers having a fourth junctional groups such as vinyl, amino, epoxy, carboxyl, hydroxyl, or isocyanate may be used. Preferred examples include epoxy resins, polyurethanes, polyesters, acrylic resins, polyamides, and silicone resins.

The reaction of the adhesion promoter or crosslinker may be carried out immediately following the low-surface-energy compound treatment. For example, when the formation of the second particles is completed, the adhesion promoter or crosslinker is added to the reaction mixture and reacted at a temperature between 0-200° C. for 1 minute to 48 hours.

In the coating material of the invention, an additive can be optionally added to aid the application of the coating material to substrate. For example, a binder may be added to facilitate the binding of the coating material to the substrate.

The second particles formed by the invention preferably have sizes less than 400 nm, more preferably less than 100 nm or even 40 nm. Preferably, the coating material may be prepared by reaction of 0.1-30 wt % of the first particles, 0.1-30 wt % of the low-surface-energy compound, 0-10 wt % of adhesion promoter or crosslinker, 0-30 wt % of the additive or binder and appropriate amounts of solvent, based on the total weight of the coating material.

The coating material may be applied to a substrate to form a coating by any known technique of forming a coating from a liquid, such as spin coating, dip coating, spray coating, brush coating, or roller coating. The coating may be dried or cured at a temperature between room temperature and 250° C. over a period of 1 minute to 48 hours. Note that the drying temperature and time may vary depending on the type of particles, melting point of the substrate, curing condition of used chemicals, and thickness of the coating. Surfaces which can be treated with the coatings of the invention include glass, ceramic, rock, plastics, metal, or polymer, but other materials or composites are also applicable.

Importantly, in coatings of the invention at a wavelength between 400-800 nm, a transmittance of the coating is greater than about 80% preferably, greater than about 90% more preferably about 100%. Further, the coating exhibits a water contact angle of above 90° after ASTM G155 weathering test using Xe arc lamp within 1200 hours. Moreover, below 10% or even 5% area of the coating is adhered by mud (150±50 cp) after the ASTM G155 weathering test using a Xe arc lamp, within 1200 hours.

### EXAMPLE

### Example 1

10 g of TEOS, 3.46 g of water, 2 g of HCl (0.1N) and 50 ml of isopropanol were mixed and reacted at room temperature for 4-6 hours. Thereafter, 10 g of 1H, 1H, 2H, 2H-perfluorodecyltriethoxysilane (fluorosilane) (F-8261, Degussa) and 400 ml of isopropanol were added to the reaction mixture and reacted at room temperature for 2-4 hours with the pH value controlled at about 2-7. Following this, 4% of BYK-354 (polyacrylate solution, BYK Chemie) were added and reacted at room temperature for 1 hour. The resulting aggregate material was applied to a glass or ceramic substrate and the substrate was burnished with a wiper.

### Examples 2-13

The same procedure as in Example 1 was repeated, except for the substitution of the ingredients listed in Table 1.

TABLE 1
Examples 2-13

| | TEOS | Water | HCl(0.1N) | Isopropanol | F-8261 | additive |
|---|---|---|---|---|---|---|
| Example 2 | 10 g | 3.46 g | 4 g | 50 mL | 10 g | 2% BYK-333 |
| | | | | | | (BYK Chemie) |
| Example 3 | 10 g | 3.46 g | 4 g | 50 mL | 10 g | 4% BYK-333 |
| | | | | | | (BYK Chemie) |
| Example 4 | 10 g | 3.46 g | 4 g | 50 mL | 10 g | 2% BYK-354 |
| | | | | | | (BYK Chemie) |
| Example 5 | 10 g | 3.46 g | 4 g | 50 mL | 10 g | 4% BYK-354 |
| | | | | | | (BYK Chemie) |
| Example 6 | 10 g | 3.46 g | 4 g | 50 mL | 10 g | 2% BYK-3500 |
| | | | | | | (BYK Chemie) |
| Example 7 | 10 g | 3.46 g | 4 g | 50 mL | 10 g | 4% BYK-3500 |
| | | | | | | (BYK Chemie) |
| Example 8 | 10 g | 3.46 g | 4 g | 50 mL | 10 g | 2% DC-57 (Dow |
| | | | | | | Corning) |
| Example 9 | 10 g | 3.46 g | 4 g | 50 mL | 10 g | 4% DC-57 (Dow |
| | | | | | | Corning) |
| Example 10 | 10 g | 3.46 g | 4 g | 50 mL | 7.5 g | none |
| Example 11 | 10 g | 3.46 g | 4 g | 50 mL | 5 g | none |
| Example 12 | 15 g | 3.46 g | 4 g | 50 mL | 10 g | none |
| Example 13 | 5 g | 3.46 g | 4 g | 50 mL | 10 g | none |

Transmittance Test

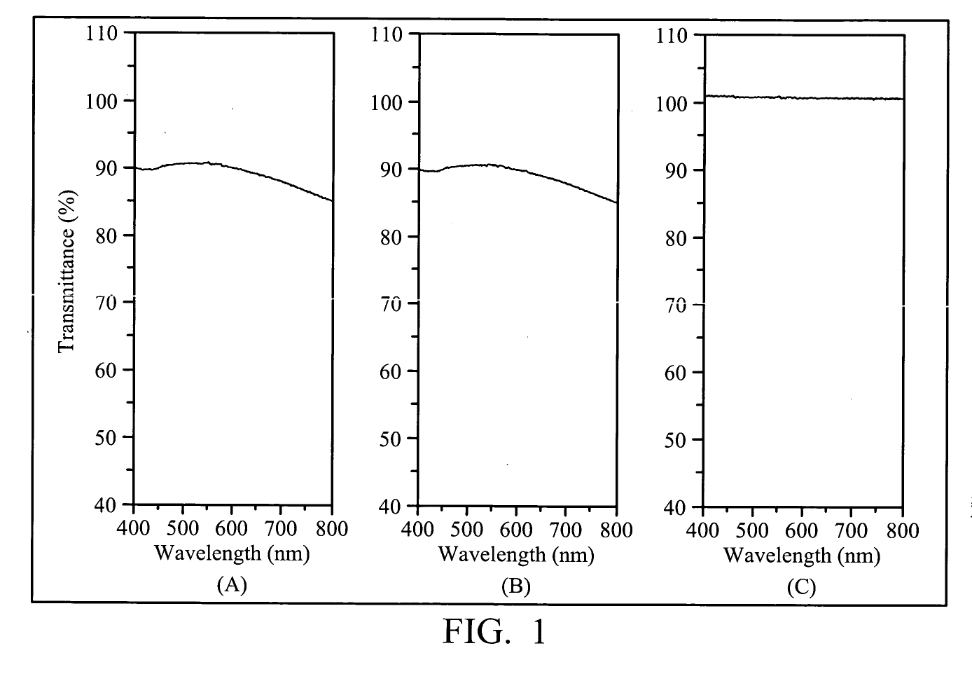

The coating material of the invention was applied to a glass substrate having a thickness of 1.1 mm. FIG. 1A shows the transmittance of the glass substrate alone. FIG. 1B shows the transmittance of the glass after application of the transparent hydrophobic self-cleaning coating material. FIG. 1C shows the transmittance of the transparent hydrophobic self-cleaning coating after deducting the transmittance of glass substrate. FIGS. 1A and 1B showed the transmittance of the glass substrate at a wavelength between 400-800 nm before and after be applied with the transparent hydrophobic self-cleaning coating material, respectively and there was almost no difference between them. Therefore the transparent hydrophobic self-cleaning coating did not decrease effect on the transmittance of the glass substrate. Moreover, after deducting the glass substrate, the transmittance of the transparent hydrophobic self-cleaning coating was almost 100% as shown in FIG. 1C. The transmittance shown in FIGS. 1A and 1B was determined by a spectrophotometer and transmittance shown in FIG. 1C was determined by a UV-visible spectroscopy.

Weathering Test

1. Water Contact Angle Test

The coating materials of Example 5 and Comparative Examples were applied to glass substrates (2.5 cm×7.5 cm) to form coatings to carry out the ASTM G155 weathering test using a Xe arc lamp and the results of the test are shown in Table 2.

The coating Example 5 exhibited an initial water contact angle of 106° and that of Comparative Example 1, 2, 3 and 5 exhibited an initial water contact angle of about 100°. However, comparative example 4 exhibited an initial water contact angle of only 95°. After irradiation by a Xe arc lamp for 1194 hours, the coating of the invention still exhibited a water contact angle of about S95° and coatings of all comparative examples exhibited a water contact angle of below 75°. Therefore, the coating of the invention showed outstanding hydrophobicity and weatherability.

TABLE 2
Water contact angle test

| | Water contact angle | | | | | |
|---|---|---|---|---|---|---|
| | | | | | | Comparative |
| | | | | | | Example 5 |
| | | | | | | MM |
| | | | Comparative | | | MEICHIVMEI |
| | | | Example 2 | | | Water |
| | | Comparative | Magic Shield ™ | | | Dispelling |
| | | Example 1 | Glass | Comparative | Comparative | Agent (PAO |
| | | glaćo Mirror | Treatment | Example 3 | Example 4 | LIN Chemical |
| | Example 5 | coat | (Technology | Super glaćo | JET glaćo W | Industrial Co., |
| Time (hours) | The invention | (SOFT 99) | Services, Inc.) | (SOFT 99) | (SOFT 99) | LTD.) |
| 0 | 106° | 99.8° | 105.6° | 103.7° | 94.6° | 105.9° |
| 194 | 98.2° | 86.8° | 95.5° | 96.9° | 82.2° | 96.3° |
| 394 | 99.9° | 82° | 85.9° | 91.9° | 73.6° | 91.5° |
| 594 | 96.9° | 67.2° | 69.6° | 90.6° | 69° | 80.4° |
| 794 | 93.2° | 57.2° | 52.5° | 76.4° | 58.9° | 62.7° |
| 994 | 95.6° | 54.3° | 63° | 78.2° | 59.8° | 65.9° |
| 1194 | 94.8° | 62.2° | 66.3° | 73.7° | 65.3° | 74.2° |

Mud Adhesion Test

The coating materials of Example 5 and Comparative Examples were applied to glass substrates (2.5 cm×7.5 cm) to form coatings and the glass substrates were then pasted with mud (150±50 cp) to carry out the ASTM G155 weathering test using a Xe arc lamp. The mud adhesion test was performed and the results (adhesion area %) of the test are shown in Table 3.

Procedure for Mud Adhesion Test

A. Preparation

A-1 Reagents and Materials

Slurry for sanitary porcelain: about 60 wt % of kaolin and clay, about 40 wt % of feldspar and china stone, etc.; ASTM325 mesh residues less than 6%; Specific weight: 1.73-1.80)

Carboxymethyl Cellulose (CMC) solution (1%)

Olive oil.

A-2 Preparation for Mud

100 g of slurry for sanitary porcelain, 100 g of CMC solution (1%) and 1 g of olive oil were mixed to form the mud. The viscosity of mud was 150±50 cp.

B. Procedure for Mud Adhesion Test

B-1: The glass substrates with coating were dipped in to mud and taken out immediately. Then glass substrates were dried vertically for 10 seconds.

B-2: The area of the coating adhered by mud was checked.

In Table 3, at first, the coatings of the invention and comparative examples were all free from adhesion of mud (150±50 cp) except for Comparative Example 5. After 1194 hours, mud was adhered to 0% area of the coating of the invention (150±50 cp) but mud was adhered to more than 30% area of the coatings of comparative examples (150±50 cp). Moreover, mud was adhered to 100% area of the coating of comparative example 1. The coating of the invention thus exhibited excellent anti-contamination ability and weatherability.

TABLE 3
Mud adhesion test

| | The area of the coating was adhered by mud (%) | | | | | |
|---|---|---|---|---|---|---|
| | | | | | | Comparative |
| | | | | | | Example 5 |
| | | | | | | MM |
| | | | Comparative | | | MEICHIVMEI |
| | | | Example 2 | | | Water |
| | | Comparative | Magic Shield ™ | | | Dispelling |
| | | Example 1 | Glass | Comparative | Comparative | Agent (PAO |
| | | glaćo Mirror | Treatment | Example 3 | Example 4 | LIN Chemical |
| | Example 5 | coat | (Technology | Super glaćo | JET glaćo W | Industrial Co., |
| Time (hours) | The invention | (SOFT 99) | Services, Inc.) | (SOFT 99) | (SOFT 99) | LTD.) |
| 0 | 0 | 0 | 0 | 0 | 0 | 3 |
| 194 | 0 | 2 | 1 | 0 | 1 | 0 |
| 394 | 0 | 17 | 13 | 2 | 7 | 3 |
| 594 | 0 | 67 | 50 | 7 | 40 | 57 |
| 794 | 0 | 77 | 44 | 7 | 50 | 60 |
| 994 | 0 | 100 | 57 | 9 | 50 | 57 |
| 1194 | 0 | 100 | 84 | 34 | 64 | 64 |

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for forming a transparent hydrophobic self-cleaning coating material, comprising:
(a) providing particle precursors to form first particles; and
(b) reacting first particles with a low-surface-energy compound to form second particles, wherein the first particles are chemically bonded to the low-surface-energy compound and diameters of the second particles are less than 400 nm.

2. The method as claimed in claim 1, wherein the particle precursors comprise tetramethoxysilane (TMOS), tetraethoxysilane (TEOS), titanium tetraisopropoxide, titanium tetramethoxide, titanium tetraethoxide, titanium, tetrabutoxide or zirconium n-butoxide.

3. The method as claimed in claim 1, wherein the low-surface-energy compound is a Si-based low-surface-energy compound comprising siloxane, silane, or silicone.

4. The method as claimed in claim 1, wherein the low-surface-energy compound is a F-based low-surface-energy compound comprising fluorosilanes, fluoroalkyl silanes (FAS), polytetrafluoroethylene (PTFE), polytrifluoroethylene, polyvinylfluoride, or functional fluoroalkyl compounds.

5. The method as claimed in claim 1, wherein the low-surface-energy compound is a carbohydrate or hydrocarbon low-surface-energy compound comprising reactive wax, polyethylene, or polypropylene.

6. The method as claimed in claim 1, wherein the low-surface-energy compound comprises a first functional group capable of bonding with the first particles, wherein the first functional group comprises SiOR or SiOH, where R is CH₃, C₂H₅, C₃H₇ or C₄H₉.

7. The method as claimed in claim 1, further comprising modifying surfaces of the first particles to comprise a second-functional group capable of bonding directly with the low-surface-energy compound, wherein the second functional group comprises amino, epoxy, carboxyl or hydroxyl.

8. The method as claimed in claim 1, wherein the first particles and the low-surface-energy compound chemically bond to each other at a pH of about 1-8.

9. The method as claimed in claim 1, after forming the second particles further comprising attaching a adhesion promoter or crosslinker to the second particles by reaction with the low-surface-energy compound or the second particles.

10. The method as claimed in claim 9, wherein the low-surface-energy compound comprises a third functional group capable of bonding with the adhesion promoter or crosslinker.

11. The method as claimed in claim 10, wherein the third functional group comprises vinyl, amino, epoxy, carboxyl, hydroxyl, or isocyanate.

12. The method as claimed in claim 11, wherein the adhesion promoter or crosslinker comprises a fourth functional group comprising vinyl, amino, epoxy, carboxyl, hydroxyl, or isocyanate.

13. The method as claimed in claim 11, wherein the adhesion promoter or crosslinker comprises epoxy resins, polyurethanes, polyesters, acrylic resins, polyamides, or silicone resins.

14. The method as claimed in claim 1, wherein the second particle diameters are less than 100 nm.

15. The method as claimed in claim 1, wherein the second particle diameters are less than 40 nm.

16. A transparent hydrophobic self-cleaning coating material formed by a process comprising:
(a) providing particle precursors to form first particles; and
(b) reacting first particles with a low-surface-energy compound to form second particles, wherein the first particles are chemically bonded to the low-surface-energy compound and diameters of the second particles are less than 400 nm.

17. The coating material as claimed in claim 16, wherein the low-surface-energy compound comprises a first functional group capable of bonding with the first particles and the first functional group (comprises SiOR or SiOH, wherein R is CH₃, C₂H₅, C₃H₇ or C₄H₉.

18. The coating material as claimed in claim 16, further comprising modifying surfaces of the first particles with a second functional group capable of bonding directly with the low-surface-energy compound, wherein the second functional group comprises amino, epoxy, carboxyl or hydroxyl.

19. The coating material as claimed in claim 16, after forming the second particles further comprising attaching a adhesion promoter or crosslinker to the second particles by reaction with the tow-surface-energy compound or the second particles.

20. The coating material as claimed in claim 16, wherein the second particle diameters are less than 100 nm.

21. The coating material as claimed in claim 16, wherein the second particle diameters are less than 40 nm.

22. A transparent hydrophobic self-cleaning coating formed by a process comprising the steps of:
(a) providing the coating material as claimed in claim 16;
(b) applying the coating material on a substrate; and
(c) drying or curing the coating material to form a transparent hydrophobic self-cleaning coating.

23. The coating as claimed in claim 22, wherein the coating material is applied to the substrate using spin coating, dip coating, spray coating, brush coating, or roller coating.

24. The coating as claimed in claim 22, wherein the coating material be dried or cured at a temperature between room temperature and 250° C.

25. The coating as claimed in claim 22, wherein the substrate comprises glass, ceramic, rock, plastics, metal or polymer.

26. The coating as claimed in claim 22, wherein at a wavelength between 400-800 nm, a transmittance of the coating is greater than about 80%.

27. The coating as claimed in claim 22, wherein at a wavelength between 400-800 nm, a transmittance of the coating is greater than about 90%.

28. The coating as claimed in claim 22, wherein at a wavelength between 400-800 nm, a transmittance of the coating is; about 100%.

29. The coating as claimed in claim 22, which exhibits a water contact angle of above 90° after the ASTM G155 weathering test using a Xe arc lamp within 1200 hours.

30. The coating as claimed in claim 22, wherein mud is adhered below 10% of the coating (150±50 cp) after the ASTM G155 weathering test using a Xe arc lamp, within 1200 hours.

31. The coating as claimed in claim 22, wherein mud is adhered below 5% area of the coating (150±50 cp) after the ASTM G155 weathering test using a Xe arc lamp, within 1200 hours.
